(19) United States
(12) Patent Application Publication
(10) Pub. No.: US 2025/0113128 A1
(43) Pub. Date: Apr. 3, 2025

(54) LOUDSPEAKER MOUNTING STRUCTURE

(71) Applicant: Tymphany HK Limited, Hong Kong (HK)

(72) Inventors: FONG GAO, Taipei City (TW); LIN WU, Taipei City (TW)

(21) Appl. No.: 18/733,578

(22) Filed: Jun. 4, 2024

(30) Foreign Application Priority Data
Sep. 28, 2023 (CN) 202322692306.5

(51) Int. Cl. H04R 1/02

(52) U.S. Cl. CPC H04R 1/021; H04R 1/025; H04R 1/026; H04R 2201/021

(57) ABSTRACT

A loudspeaker mounting structure includes a case, a first cover, a second cover and a limiting module. The case is recessed inwardly with a groove. The first cover and the second cover are disposed on the upper surface and the lower surface of the case. The case, the first cover and the second cover form an accommodation cavity where a loudspeaker is mounted. The limiting module is disposed in the groove and includes a stud and a limiting component rotatably connected to the stud.

### CROSS REFERENCE TO RELATED APPLICATIONS

This application claims priority of Application No. CN202322692306.5 filed in China on Sep. 28, 2023 under 35 U.S.C. § 119, the entire contents of which are hereby incorporated by reference.

### FIELD OF THE INVENTION

The present disclosure relates to a field of mounting and embedding a loudspeaker, and particularly relates to a loudspeaker mounting structure configured to mount the loudspeaker on a ceiling or a sprung roof.

### BACKGROUND OF THE INVENTION

An embedded loudspeaker box may achieve objects of saving interior space and keeping original design styles by mounting and embedding a loudspeaker on a ceiling or a wall.

In order to mount and embed the loudspeaker, mounting holes are drilled on the ceiling or the wall at first, and then the loudspeaker is mounted on a bracket and the bracket is inserted into the mounting holes, and finally, the embedded loudspeaker is firmly fixed on the ceiling or the wall by studs. When the bracket is inserted into the mounting holes, nuts, spacers, hinges (hanging fixers) and studs are required with the bracket to cooperatively mount on the mounting holes. When there is a lack of some components such as spacers, a slip phenomenon would be generated and leads to unfirm mounting.

CN206559575U discloses an embedded loudspeaker box. The embedded loudspeaker box includes a panel, a case, a loudspeaker, a motion ring disk, an inclined plane, a stopper, an upper position inserting plate, a lower position inserting plate, a mounting frame, and a wiring hole. When the embedded loudspeaker box is mounted, the mounting frame is mounted on the wall at first and the balance of the mounting frame is adjusted, and the loudspeaker box composed of the panel, the case and the loudspeaker is inserted into the mounting frame by the stopper. When the loudspeaker box is mounted on the mounting frame, the inner upper position inserting plate and the inner lower position inserting plate collaborate with a position groove. Apparently, the number of the components in the embedded loudspeaker box is numerous, and the relative positions of the stopper and the position groove are required to consider, and it is complicated to assemble the aforementioned components.

### SUMMARY OF THE INVENTION

In order to solve the aforementioned problem in the art, the present disclosure provides a loudspeaker mounting structure with less components, and in the loudspeaker mounting structure of the present disclosure, the loudspeaker may be conveniently mounted and embedded on the external connection component such as a ceiling or a wall.

In order to achieve the aforementioned object, the present disclosure, in one embodiment, provides a loudspeaker mounting structure including a case, a first cover, a second cover and a limiting module. The case is recessed inwardly with a groove. The first cover is disposed on the upper surface of the case. The second cover is disposed on the lower surface of the case, and the case, the first cover and the second cover form an accommodation cavity where a loudspeaker is mounted. The limiting module is disposed in the groove and includes a stud and a limiting component. The limiting component is rotatably connected to the stud and is fixed and connected to an external connection component.

In the loudspeaker mounting structure, the loudspeaker is mounted on the accommodation cavity formed by the case, the first cover, and the second cover. The case is fixed on the external connection component such as a ceiling or a wall by the limiting module disposed in the groove to achieve the embedded mounting of the loudspeaker. During the mounting of the loudspeaker mounting structure, the limiting component of the limiting module may rotate along the stud, thereby adjusting the mounting position of the loudspeaker mounting structure.

In some embodiments of the present disclosure, the limiting component includes a hanging part and a limiting part. The hanging part protrudes from the groove, and the limiting part contacts the groove.

In some embodiments of the present disclosure, an angle is formed between the hanging part and the limiting part.

In some embodiments of the present disclosure, the angle is between 45° and 120°.

When the hanging part is fixed on the external connection component, the limiting part contacts the groove and has an effect of limiting like gears to prevent the stud from slipping off the mounting position of the stud. The angle is formed between the hanging part and the limiting part and is between 45° and 120°. Preferably, the angle is 90° and in other words, the limiting part is vertical to the hanging part, thereby ensuring that the mounting position of the case in the external connection component is fixed and the stud is not loosened.

In some embodiments of the present disclosure, the groove has a structure in which a width of an inner side is less than a width of an outer side, and the shape of the cross section of the groove is a trapezoid.

In some embodiments of the present disclosure, the stud includes a nut part and a rotary shaft part, and screw threads are disposed on the rotary shaft part. The external connection component is a ceiling, a sprung roof or a wall.

In some embodiments of the present disclosure, an inserting groove is disposed on the second cover, and a through hole is disposed on the first cover. The nut part is connected to and is engaged with the inserting groove, and the rotary shaft part passes through the through hole.

In some embodiments of the present disclosure, the opening of the inserting groove is parallel to the bottom surface of the groove.

In some embodiments of the present disclosure, the second cover and the case are integrally formed.

In order to achieve the aforementioned object, the present disclosure, in another embodiment, provides a loudspeaker mounting structure including a case, a cover, a stud and a limiting component. The case is recessed inwardly with a groove, and a loudspeaker is mounted inside the case. The stud is disposed in the groove and connected to the cover. The limiting component is disposed in the groove and is rotatably connected to the stud. The limiting component includes a limiting part and a hanging part. The hanging part is connected to an external connection component, and the limiting part contacts the groove.

According to the above description, the present disclosure has beneficial effects as follows.

In the loudspeaker mounting structure of the present disclosure, the limiting component of the limiting module may rotate along the stud, thereby adjusting the mounting position of the stud. When the loudspeaker mounting structure is mounted completely, the hanging part of the limiting component is fixed and connected to the external connection component, such as the ceiling or the wall and the limiting part contacts the groove to prevent the stud from slipping off the groove and ensure that mounting position of the stud is fixed.

In the loudspeaker mounting structure of the present disclosure, the limiting module merely consists of the stud and the limiting component, and the loudspeaker may be conveniently mounted and embedded on the external connection component such as the ceiling or the wall so that the components such as nuts and spacers are saved, thereby saving the manufacturing cost of the loudspeaker mounting structure and improving the mounting efficiency of the loudspeaker mounting structure.

### BRIEF DESCRIPTION OF THE DRAWINGS

FIG. 1 is an exploded view diagram of a loudspeaker mounting structure according to one embodiment of the present disclosure.

FIG. 2 is an assembled product diagram of a loudspeaker mounting structure according to one embodiment of the present disclosure.

FIG. 3 is a top view diagram of a case and a second cover according to one embodiment of the present disclosure.

FIG. 4 is a structural schematic diagram of a limiting module according to one embodiment of the present disclosure.

FIG. 5 is a structural schematic diagram of a limiting component according to one embodiment of the present disclosure.

### DETAILED DESCRIPTION

In order easily understand the present disclosure, the following content will be described clearly and completely with reference to accompanying drawings and in conjunction with the embodiments. The accompanying drawings merely reveal the preferred implementation of the present disclosure. However, the present disclosure may be revealed in different forms and may be not limited to the implementation described in the present disclosure. Conversely, the object of providing the preferred implementation is to understand the content disclosed by the present disclosure thoroughly.

It should be noted that when one element “is fixed on” or “is disposed on” another element, it may be directly on another element or there is a middle element between two elements. When one element “is connected to” another element, it may be directly connected to another element or there is a middle element between two elements.

Unless otherwise defined, all terms including technical and scientific terms used herein have the same meaning as commonly understood by a person skilled in the art. The terms used in the present disclosure is to describe the implementation of the present disclosure specifically and the present disclosure is not limited thereto.

### First Embodiment

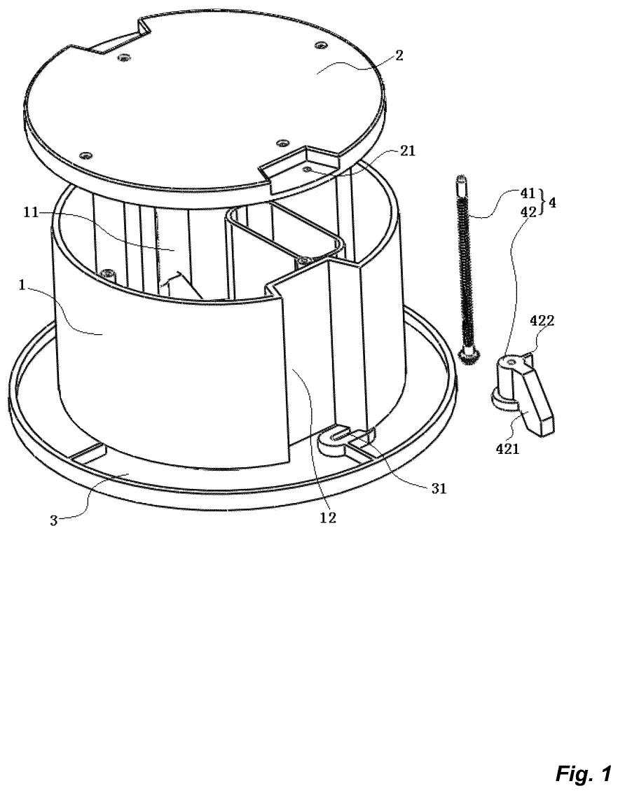

With reference to FIG. 1 to FIG. 5, the present disclosure provides a loudspeaker mounting structure including a case 1, a first cover 2 and a second cover 3. The first cover 2 is located above the case 1, and the first cover 2 may be fixed on the case 1 by locking screws. The second cover 3 is located below the case 1, and the case 1 and the second cover 3 may be separately disposed or be integrally formed. When the case 1 and the second cover 3 are separately disposed, the case 1 is fixed on the second cover 3 by attaching or locking screws. When the case 1 and the second cover 3 are integrally formed, the case 1 and the second cover 3 forms a one-piece structure by injection molding or stamping. In another embodiment, the case 1 and the first cover 2 forms a one-piece structure.

The case 1, the first cover 2 and the second cover 3 form an accommodation cavity 11. The accommodation cavity 11 is configured to mount electronic components, such as loudspeakers or accommodate an audio system. In other words, the case 1, the first cover 2 and the second cover 3 form a bracket, and the bracket is configured to mount audio electronic components, such as the loudspeakers, on an external connection component. It should be mentioned that the external connection component is an obscuring body, such as a ceiling, a sprung roof or a wall where the loudspeakers may be mounted and embedded. It is easily understood that the external connection component is easily drilled.

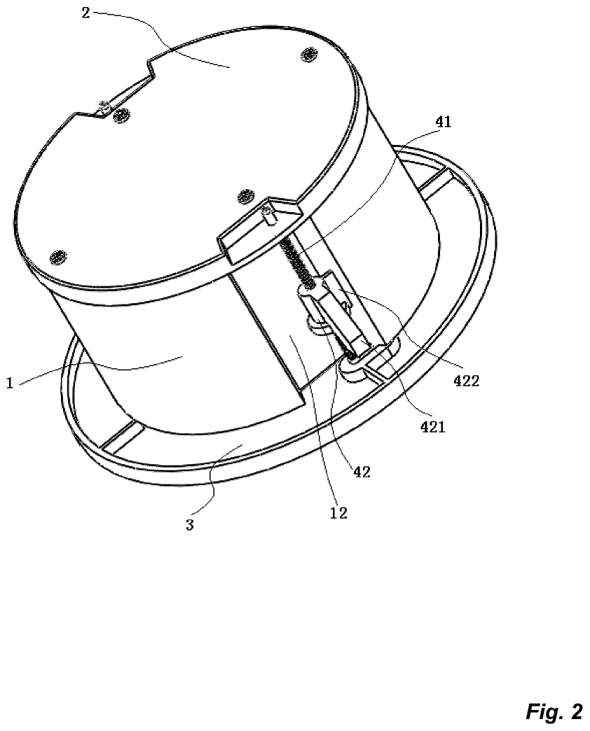

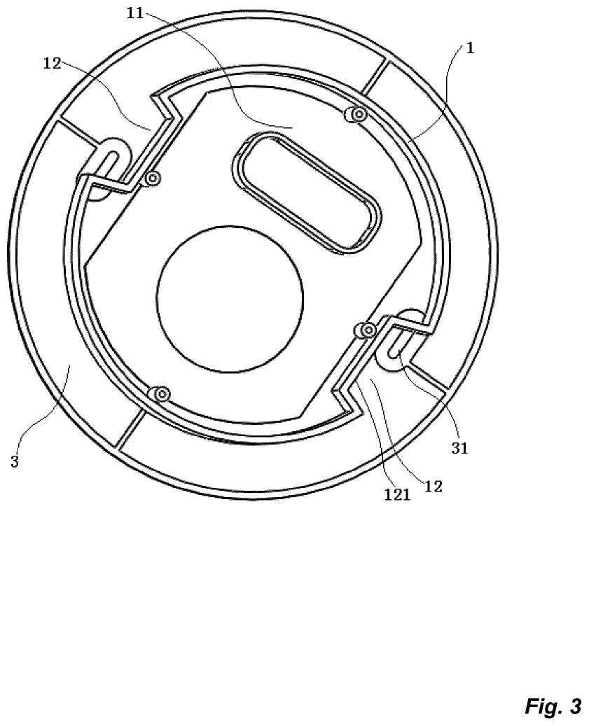

The case 1 in the present embodiment is recessed inwardly with a groove 12. As shown in FIG. 2 and FIG. 3, the case 1 forms two grooves 12 which are relatively disposed. The structure of each of the two grooves 12 is a structure in which a width of an inner side is less than a width of an outer side, and the shape of the cross section of the groove is a trapezoid. According to mounting requirements, the number of the grooves 12 may be three and the arrangement of the grooves 12 may be adjusted based on the design.

Two limiting modules 4 are disposed in the groove 12 and are configured to be fixed with the external connection component. As illustrated in FIG. 1 and FIG. 2, each of the two limiting modules 4 includes a stud 41 and a limiting component 42. The stud 41 passes through the groove 12, and the limiting component 42 is rotatably connected to the stud 41.

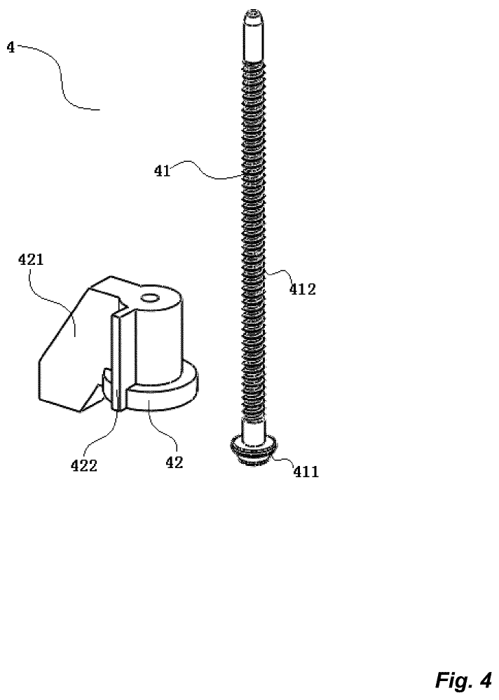

Specifically, as shown in FIG. 4, the stud 41 includes a nut part 411 and a rotary shaft part 412. The nut part 411 extends from one terminal of the stud 41 to the peripheral side of the stud 41 and is configured to be fixed with the second cover 3. The rotary shaft part 412 serves as the rotary shaft of the limiting component 42, and screw threads are disposed on the appearance of the rotary shaft part 412. The rotary shaft part 412 provides the limiting component 42 to rotate for performing the adjustment on the position of the limiting component 42. In the present embodiment, the screw threads are disposed on the rotary shaft part 412 located in the groove 12, and in other words, the adjustment of the position of the limiting component 42 may be performed in the entire groove 12. The screw threads are not disposed on the tail end of the rotary shaft part 412, and the tail end of the rotary shaft part 412 is smooth and is configured to be fixed with the first cover 2.

Referring to FIG. 1 and FIG. 3, two inserting grooves 31 are disposed on the second cover 3 and are respectively located below the two grooves 12, and preferably, the openings of the two inserting grooves 31 are parallel to the bottom surfaces 121 of the two grooves 12, and the openings of the inserting grooves 31 may be adjusted according to configuration requirements. Two through holes 21 are disposed on the first cover 2.

When the loudspeaker mounting structure is mounted, the two limiting components 42 are respectively disposed in the two grooves 12 and the nut parts 411 of the two studs 41 are connected to and are engaged with the two inserting grooves 31 respectively. Afterwards, the nut parts 411 of the two studs 41 are screwed in the two limiting components 42, and the tail ends of the two rotary shaft part 412 pass through the two through holes 21 of the first cover 2, and finally, the two studs 41 are moved in the two grooves 12. It could be understood that each of the two inserting grooves 31 is a groove structure with a two-staged concave groove, and a grooving size of an outer concave groove is greater than a grooving size of an inner concave groove. Each of the two nut parts 411 is placed on the outer concave groove at first and then is moved in the inner concave groove, thereby screwing the two nut parts 411 to the two inserting grooves 31.

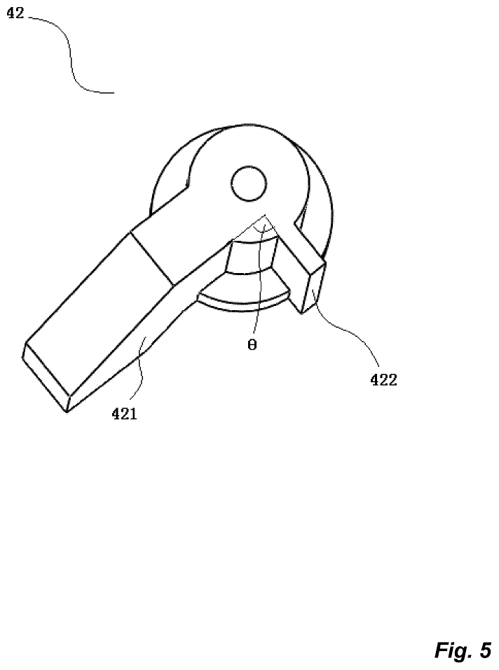

Referring to FIG. 4 and FIG. 5, each of the two limiting component 42 includes a hanging part 421 and a limiting part 422. The hanging part 421 protrudes from the corresponding groove 12 and is finally fixed on the connection component, such as the ceiling, the sprung roof or the wall. After the stud 41 is mounted completely and the adjustment of the position of the limiting component 42 is finished, the limiting part 422 contacts the corresponding groove 12 to prevent the nut part 411 from slipping off the corresponding inserting groove 31 and to prevent stud 41 from slipping off the mounting position of the corresponding groove 12.

As shown in FIG. 5, an angle θ is formed between the hanging part 421 and the limiting part 422, and the numerical range of the angle θ is between 45° and 120°. In the present embodiment, the angle θ is 90°, and in other words, the limiting part 422 is vertical to the hanging part 421, thereby ensuring that the mounting position of the case 1 in the external connection component is fixed and the stud 41 is not loosened.

In the loudspeaker mounting structure provided by the present embodiment of the present disclosure, the limiting module merely consists of the stud and the limiting component, and the loudspeaker may be conveniently mounted and embedded on the external connection component, such as the ceiling or the wall so that the components such as nuts and spacers are saved, thereby saving the manufacturing cost of the loudspeaker mounting structure and improving the mounting efficiency of the loudspeaker mounting structure.

The aforementioned content is merely to describe the structure of the present disclosure for example and the description of the aforementioned content is detailed and specific, but the aforementioned content could not be construed as limitations of the present disclosure. It should be noted that the person skilled in the art would have changes and modification in specific implementation and application scope without departing from the idea of the present disclosure. These obvious modification and changes according to the idea and the spirit of the present disclosure should be included within the protection scope of the present disclosure.

### LIST OF REFERENCE SIGNS

1: case
2: first cover
3: second cover
4: limiting module
11: accommodation cavity
12: groove
21: through hole
31: inserting groove
41: stud
42: limiting component
121: bottom surface
411: nut part
412: rotary shaft part
421: hanging part
422: limiting part

1. A loudspeaker mounting structure, comprising:
a case recessed inwardly with a groove;
a first cover disposed on an upper surface of the case;
a second cover disposed on a lower surface of the case, wherein the case, the first cover and the second cover form an accommodation cavity configured to receive a loudspeaker; and
a limiting module disposed in the groove and comprising:
a stud; and
a limiting component rotatably connected to the stud and configured to be connected to an external connection component.

2. The loudspeaker mounting structure according to claim 1, wherein the limiting component comprises:
a hanging part protruding from the groove; and
a limiting part contacting the groove.

3. The loudspeaker mounting structure according to claim 2, wherein an angle is formed between the hanging part and the limiting part.

4. The loudspeaker mounting structure according to claim 3, wherein the angle is between 45° and 120°.

5. The loudspeaker mounting structure according to claim 1, wherein the groove has a structure in which a width of an inner side is less than a width of an outer side, and
wherein a shape of a cross section of the groove is a trapezoid.

6. The loudspeaker mounting structure according to claim 1, wherein the stud comprises a nut part and a rotary shaft part,
wherein screw threads are disposed on the rotary shaft part, and
wherein the external connection component is a ceiling, a sprung roof or a wall.

7. The loudspeaker mounting structure according to claim 6, further comprising:
an inserting groove disposed on the second cover; and
a through hole disposed on the first cover,
wherein the nut part is connected to and is engaged with the inserting groove, and
wherein the rotary shaft part passes through the through hole.

8. The loudspeaker mounting structure according to claim 7, wherein an opening of the inserting groove is parallel to a bottom surface of the groove.

9. The loudspeaker mounting structure according to claim 7, wherein the second cover and the case are integrally formed.

10. A loudspeaker mounting structure, comprising:
a case recessed inwardly with a groove, the case being configured to mount a loudspeaker inside the case;
a cover;
a stud disposed in the groove and connected to the cover; and
a limiting component disposed in the groove and rotatably connected to the stud, wherein the limiting component comprises a hanging part connected to an external connection component and a limiting part contacting the groove.
